(19) United States
(12) Patent Application Publication
(10) Pub. No.: US 2022/0204046 A1
(43) Pub. Date: Jun. 30, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Tomoyuki Hosoya, Wako-shi (JP); Sho Hitakatsu, Wako-shi (JP); Toshikazu Suwa, Tokyo (JP); Masaki Nakajima, Yokohama-shi (JP)

(21) Appl. No.: 17/557,307

(22) Filed: Dec. 21, 2021

(30) Foreign Application Priority Data
Dec. 28, 2020 (JP) 2020-218247

(51) Int. Cl. B60W 60/00; G01S 19/48; G01S 19/49

(52) U.S. Cl. CPC B60W 60/0053; B60W 60/001; G01S 19/49; G01S 19/485

(57) ABSTRACT

A vehicle control device includes: a first measurer measures a position (hereinafter referred to as a first position) of a vehicle based on radio waves coming from artificial satellites; a second measurer measures the position (hereinafter referred to as a second position) of the vehicle based on a behavior of the vehicle; a determiner determines a correction amount of the second position based on a difference between the first position and the second position; and a driving controller performs automated driving of the vehicle based on the first position or the second position corrected based on the correction amount, wherein when the correction amount is not determined, the driving controller lowers the control level of the automated driving in a shorter travel distance or travel time under a condition that the first position is not measured as compared with a case where the correction amount is determined.

### CROSS-REFERENCE TO RELATED APPLICATION

This application claims priority to and the benefit from Japanese Patent Application No. 2020-218247, filed on Dec. 28, 2020, the contents of which are hereby incorporated by reference into the present application.

### BACKGROUND

### Field of the Invention

The present invention relates to a vehicle control device, a vehicle control method, and a storage medium.

### Description of Related Art

Conventionally, a navigation system configured such that a first travel distance of a host vehicle in a predetermined section is calculated based on the host vehicle speed calculated using a vehicle speed pulse and a vehicle speed calculation coefficient, and a second travel distance of the host vehicle in the predetermined section is calculated based on global positioning system (GPS) information provided from positioning satellites, a vehicle speed calculation coefficient is corrected based on a comparison result between the first travel distance and the second travel distance, and the position of the host vehicle is predicted based on the host vehicle speed calculated using the vehicle speed pulse and the corrected vehicle speed calculation coefficient is known (for example, see Japanese Patent Application Publication No. 2011-117739).

### SUMMARY

In the conventional technology, it is not sufficiently considered under what conditions the control level of automated driving is changed when performing the automated driving using the corrected index after correcting the index indicating the behavior of the host vehicle such as a vehicle speed pulse.

The present invention has been made in view of such circumstances, and one of the objects thereof is to provide a vehicle control device, a vehicle control method, and a storage medium capable of changing the control level of automated driving under appropriate conditions.

A vehicle control device, a vehicle control method, and a storage medium according to the present invention employ the following configurations.

(1) A vehicle control device including: a first measurer that measures a position of a vehicle based on radio waves coming from artificial satellites; a second measurer that measures the position of the vehicle based on an index that represents a behavior of the vehicle; a determiner that calculates a difference between a first position, which is the position of the vehicle measured by the first measurer, and a second position, which is the position of the vehicle measured by the second measurer, and determines a correction amount of the second position based on the calculated difference; and a driving controller that performs automated driving of the vehicle based on the first position measured by the first measurer or the second position corrected based on the correction amount determined by the determiner, wherein when the correction amount is not determined by the determiner, the driving controller lowers a control level of the automated driving in a shorter travel distance or travel time under a condition that the first position is not measured by the first measurer as compared with a case where the correction amount is determined by the determiner.

(2) The vehicle control device according to (1), wherein the first measurer repeatedly measures the first position, the second measurer repeatedly measures the second position, the determiner repeats calculating the difference between the first position and the second position corrected based on the correction amount and determining the correction amount based on the calculated difference each time the first position and the second position are repeatedly measured, and when the first position is not measured by the first measurer, the driving controller performs the automated driving based on the second position corrected based on the correction amount determined latest or the correction amount having the smallest difference among a plurality of correction amounts determined repeatedly by the determiner.

(3) The vehicle control device according to (2), wherein the driving controller increases the travel distance or the travel time until the control level of the automated driving is lowered as the number of repetitions of the determination of the correction amount increases.

(4) The vehicle control device according to any one of (1) to (3), wherein the driving controller further lowers the control level of the automated driving when an turning angle when the vehicle turns in the same direction exceeds a predetermined angle.

(5) A vehicle control method for causing a computer mounted on a vehicle to execute: measuring a position of a vehicle based on radio waves coming from artificial satellites; measuring the position of the vehicle based on an index that represents a behavior of the vehicle; calculating a difference between a first position, which is the position of the vehicle measured based on the radio waves, and a second position, which is the position of the vehicle measured based on the index, and determining a correction amount of the second position based on the calculated difference; and performing automated driving of the vehicle based on the first position measured or the second position corrected based on the correction amount; when the correction amount is not determined by the determiner, lowering a control level of the automated driving in a shorter travel distance or travel time under a condition that the first position is not measured as compared with a case where the correction amount is determined.

(6) A computer-readable non-transitory storage medium storing a program for causing a computer mounted on a vehicle to execute: measuring a position of a vehicle based on radio waves coming from artificial satellites; measuring the position of the vehicle based on an index that represents a behavior of the vehicle; calculating a difference between a first position, which is the position of the vehicle measured based on the radio waves, and a second position, which is the position of the vehicle measured based on the index, and determining a correction amount of the second position based on the calculated difference; and performing automated driving of the vehicle based on the first position measured by the first measurer or the second position corrected based on the correction amount; when the correction amount is not determined, lowering the control level of the automated driving in a shorter travel distance or travel time under a condition that the first position is not measured as compared with a case where the correction amount is determined.

According to the above-described aspects, the control level of automated driving can be changed under appropriate conditions.

### BRIEF DESCRIPTION OF THE DRAWINGS

FIG. 1 is a block diagram of a vehicle system using the vehicle control device according to the embodiment.

FIG. 2 is a diagram illustrating a functional configuration of a first controller and a second controller.

FIG. 3 is a diagram illustrating an example of correspondence between a driving mode, a control state of the host vehicle, and a task.

FIG. 4 is a flowchart illustrating an example of a training process by the vehicle system.

FIG. 5 is a diagram showing convergence determination of a correction amount.

FIG. 6 is a flowchart illustrating an example of runtime processing at the time of abnormality by the vehicle system.

FIG. 7 is a diagram illustrating an example of a situation in which the turning angle of the host vehicle M exceeds a predetermined angle.

### DESCRIPTION OF EMBODIMENTS

Hereinafter, embodiments of a vehicle control device, a vehicle control method, and a storage medium of the present invention will be described with reference to the drawings.

### Overall Configuration

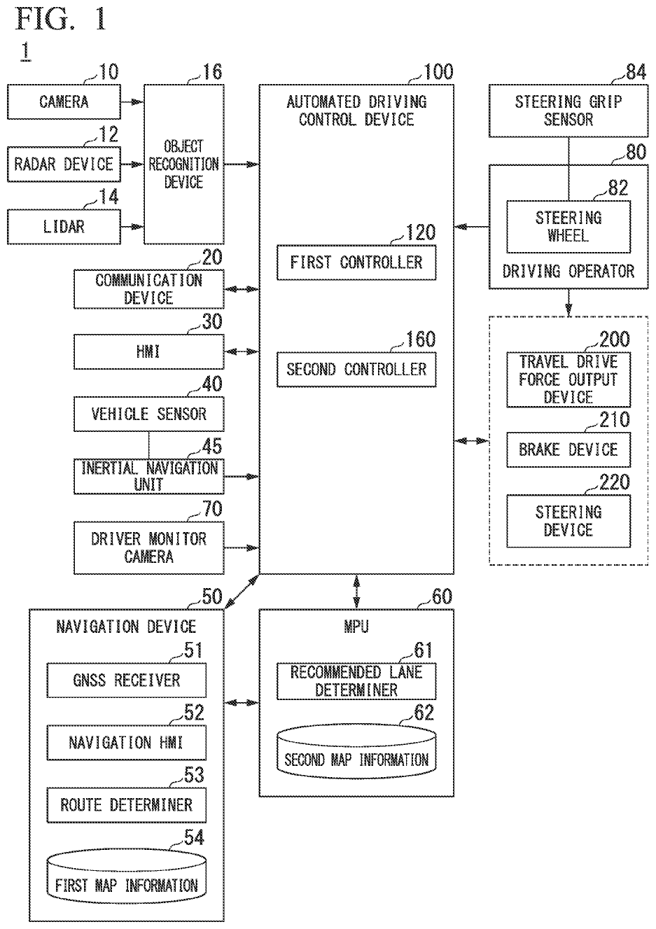

FIG. 1 is a block diagram of a vehicle system 1 using a vehicle control device according to the embodiment. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. An electric motor operates using electric power generated by a generator connected to an internal combustion engine or electric power discharged by secondary batteries or fuel-cell batteries.

The vehicle system 1 includes, for example, a camera 10, a radar device 12, a light detection and ranging (LIDAR) 14, an object recognition device 16, a communication device 20, a human machine interface (HMI) 30, a vehicle sensor 40, an inertial navigation unit (INU) 45, a navigation device 50, a map positioning unit (MPU) 60, a driver monitor camera 70, a driving operator 80, an automated driving control device 100, a travel drive force output device 200, a brake device 210, and a steering device 220. These apparatuses and devices are connected to each other by a multiplex communication line such as a controller area network (CAN) communication line, a serial communication line, a wireless communication network, and the like. Moreover, the components illustrated in FIG. 1 are examples only, some components may be omitted and other components may be added. The vehicle system 1 is an example of a “vehicle control device”.

The camera 10 is, for example, a digital camera which uses a solid-state imaging device such as a charge coupled device (CCD) or a complementary metal oxide semiconductor (CMOS). The camera 10 is attached to an arbitrary position of a vehicle (hereinafter referred to as a host vehicle M) in which the vehicle system 1 is mounted. When capturing images on the front side, the camera 10 is attached to an upper part of a front windshield or a back surface of a rear-view mirror. The camera 10, for example, captures the images around the host vehicle M repeatedly and periodically. The camera 10 may be a stereo camera.

The radar device 12 emits radio waves such as millimeter waves to the surroundings of the host vehicle M and detects radio waves (reflected waves) reflected from an object to detect at least the position (the distance and direction) of the object. One or a plurality of radar devices 12 are attached to arbitrary positions of the host vehicle M. The radar device 12 may detect the position and the speed of an object according to a frequency modulated continuous wave (FM-CW) method.

The LIDAR 14 irradiates the periphery of the host vehicle M with light (or an electromagnetic wave having a wavelength close to that of light) and measures the scattered light. The LIDAR 14 determines the distance to an object on the basis of the time taken to receive light after the light was emitted. The radiated light is pulsating laser light, for example. The LIDAR 14 is attached to an arbitrary position on the host vehicle M.

The object recognition device 16 performs sensor fusion processing on detection results obtained by some or all of the camera 10, the radar device 12, and the LIDAR 14 to recognize the position, the kind, the speed, and the like of an object. The object recognition device 16 outputs the recognition results to the automated driving control device 100. The object recognition device 16 may output the detection results obtained by the camera 10, the radar device 12, and the LIDAR 14 to the automated driving control device 100 as they are. The object recognition device 16 may be omitted from the vehicle system 1.

The communication device 20, for example, communicates with other vehicles present around the host vehicle M, or communicates with various server apparatuses via a wireless base station using a cellular network, a Wi-Fi network, Bluetooth (registered trademark), a dedicated short-range communication (DSRC), or the like.

The HMI 30 presents various pieces of information to the occupant of the host vehicle M, and accepts input operations by the occupant. The HMI 30 includes, for example, various displays, speakers, microphones, buzzers, touch panels, switches, keys, and the like.

The vehicle sensor 40 includes a vehicle speed sensor that detects the speed of the host vehicle M, an acceleration sensor that detects the acceleration, a gyro sensor that detects the angular velocity, an azimuth sensor that detects the direction of the host vehicle M, and the like. The gyro sensor may include, for example, a yaw rate sensor that detects an angular velocity around the vertical axis.

The vehicle sensor 40 further includes a wheel speed sensor 42 in addition to the various sensors described above. The wheel speed sensor 42 detects the rotation speed (rotational speed) of the wheels of the host vehicle M, and generates a pulse signal according to the detected rotation speed (rotational speed). The wheel speed sensor 42 outputs the generated pulse signal to the automated driving control device 100. The wheel rotation speed (rotational speed) detected by the wheel speed sensor 42 is an example of an “index representing behavior”.

The inertial navigation unit 45 measures or calculates the position of the host vehicle M based on the inertial force acting on the host vehicle M. For example, the inertial navigation unit 45 may calculate the position of the host vehicle M by time-integrating the speed detected by the gyro sensor included in the vehicle sensor 40, may calculate the position of the host vehicle M by calculating the speed by time-integrating the acceleration detected by the acceleration sensor and further time-integrating the speed. The inertial navigation unit 45 outputs a signal indicating the measured or calculated position of the host vehicle M to the automated driving control device 100. The angular speed detected by the gyro sensor and the acceleration detected by the acceleration sensor are other examples of the “index representing behavior”. The inertial navigation unit 45 is an example of the “second measurer”.

The navigation device 50 includes, for example, a global navigation satellite system (GNSS) receiver 51, a navigation HMI 52, and a route determiner 53. The navigation device 50 holds the first map information 54 in a storage device such as a hard disk drive (HDD) or a flash memory.

The GNSS receiver 51 receives radio waves from a plurality of GNSS satellites (artificial satellites), and measures or specifies the position of the host vehicle M based on the signals of the received radio waves. The GNSS receiver 51 outputs the measured or specified position of the host vehicle M to the route determiner 53, directly to the automated driving control device 100, or indirectly via the MPU 60.

The GNSS receiver 51 further outputs a flag signal indicating the reception status (the strength of the received signal and the presence of reception) of the radio waves of the GNSS satellites to the automated driving control device 100 directly or indirectly via the MPU 60.

The flag signal includes a positioning flag signal and a non-positioning flag signal. The positioning flag signal is a flag signal indicating that the GNSS receiver 51 could receive radio waves from the GNSS satellites, or the signal strength of the radio waves received by the GNSS receiver 51 from the GNSS satellites is equal to or higher than a threshold value. The non-positioning flag signal is a flag signal indicating that the GNSS receiver 51 could not receive radio waves from the GNSS satellites, or the signal strength of the radio waves received by the GNSS receiver 51 from the GNSS satellites is less than the threshold value. The GNSS receiver 51 is an example of the “first measurer”.

The navigation HMI 52 includes a display, a speaker, a touch panel, keys, and the like. The navigation HMI 52 may be partially or entirely shared with the HMI 30. For example, the route determiner 53 determines a route (hereinafter a map route) from the position (or an input arbitrary position) of the host vehicle M measured or specified by the GNSS receiver 51 to a destination input by an occupant using the navigation HMI 52 by referring to the first map information 54.

For example, the route determiner 53 determines the map route on the basis of the position of the host vehicle M measured or calculated by the inertial navigation unit 45 and the position of the host vehicle M estimated by a position estimator 156 described later as well as the position of the host vehicle M measured or specified by the GNSS receiver 51.

The first map information 54 is information in which a road shape is represented by links indicating roads and nodes connected by links. The first map information 54 may include the curvature of a road, point of interest (POI) information, and the like. The map route is output to the MPU 60.

The navigation device 50 may perform route guidance using the navigation HMI 52 on the basis of the map route. The navigation device 50 may be realized by the functions of a terminal device such as a smartphone or a tablet terminal held by an occupant. The navigation device 50 may transmit a present position and a destination to a navigation server via the communication device 20 and acquire a route equivalent to a map route from the navigation server.

The MPU 60 includes a recommended lane determiner 61, for example, and stores second map information 62 in a storage device such as an HDD or a flash memory. The recommended lane determiner 61 is realized when a hardware processor such as a central processing unit (CPU) or the like executes a program (software). The recommended lane determiner 61 may be realized by hardware (a circuit portion; including circuitry) such as large-scale integration (LSI), an application specific integrated circuit (ASIC), a field-programmable gate array (FPGA), or a graphics processing unit (GPU) and may be realized by the cooperation of software and hardware. The program may be stored in advance in a storage device (a storage device including a non-transitory storage medium) of the MPU 60 and may be stored in a removable storage medium such as a DVD or a CD-ROM and be installed in a storage device of the MPU 60 when a storage medium (a non-transitory storage medium) is attached to a drive device.

The recommended lane determiner 61 divides the map route provided from the navigation device 50 into a plurality of blocks (for example, the route may be partitioned every 100 [m] in relation to a vehicle traveling direction) and determines a recommended lane for each block by referring to the second map information 62. The recommended lane determiner 61 determines that the vehicle is traveling in a certain lane from the left. When a branching point is present on a map route, the recommended lane determiner 61 determines a recommended lane so that the host vehicle M can travel along a reasonable route for proceeding to a branch destination.

The second map information 62 is more accurate map information than the first map information 54. The second map information 62 includes, for example, information on the center of the lane or the boundary of the lane, information and the like. The second map information 62 may include road information, traffic regulation information, address information (address and postal codes), facility information, telephone number information, information on a prohibited section in which mode A or mode B described later is prohibited, and the like. The second map information 62 may be updated as necessary by the communication device 20 communicating with other devices.

The driver monitor camera 70 is, for example, a digital camera that uses a solid-state image sensor such as a CCD or CMOS. The driver monitor camera 70 is attached to, for example, an arbitrary portion of the host vehicle M in a position and direction in which the head of an occupant (hereinafter referred to as a driver) seated in the driver's seat of the host vehicle M can be imaged from the front (in the direction in which the face is imaged). For example, the driver monitor camera 70 is attached to the upper part of the display provided in the central portion of the instrument panel of the host vehicle M.

The driving operator 80 includes, for example, an acceleration pedal, a brake pedal, a shift lever, and other operators in addition to the steering wheel 82. Sensors that determine the amount of operation or the presence of an operation are attached to the driving operator 80, and the detection results of the sensors are output to the automated driving control device 100 or a part or all of the travel drive force output device 200, the brake device 210, and the steering device 220. The steering wheel 82 is an example of an “operator that accepts a steering operation by the driver”. The operator does not necessarily have to be circular, and may be in the form of a deformed steering wheel, a joystick, a button, or the like. A steering grip sensor 84 is attached to the steering wheel 82. The steering grip sensor 84 is realized by a capacitance sensor or the like, and outputs a signal capable of detecting whether the driver is holding the steering wheel 82 (meaning that the steering wheel 82 is in contact with force applied thereto) to the automated driving control device 100.

The automated driving control device 100 includes, for example, a first controller 120 and a second controller 160. The first controller 120 and the second controller 160 each are realized when a hardware processor such as a central processing unit (CPU) or the like executes a program (software). Some or all of these components may be realized by hardware (a circuit portion; including circuitry) such as LSI, ASIC, FPGA, or GPU and may be realized by the cooperation of software and hardware. The program may be stored in advance in a storage device (a storage device including a non-transitory storage medium) such as an HDD or a flash memory of the automated driving control device 100 and may be stored in a removable storage medium such as a DVD or a CD-ROM and be installed in a HDD or a flash memory of the automated driving control device 100 when a storage medium (a non-transitory storage medium) is attached to a drive device.

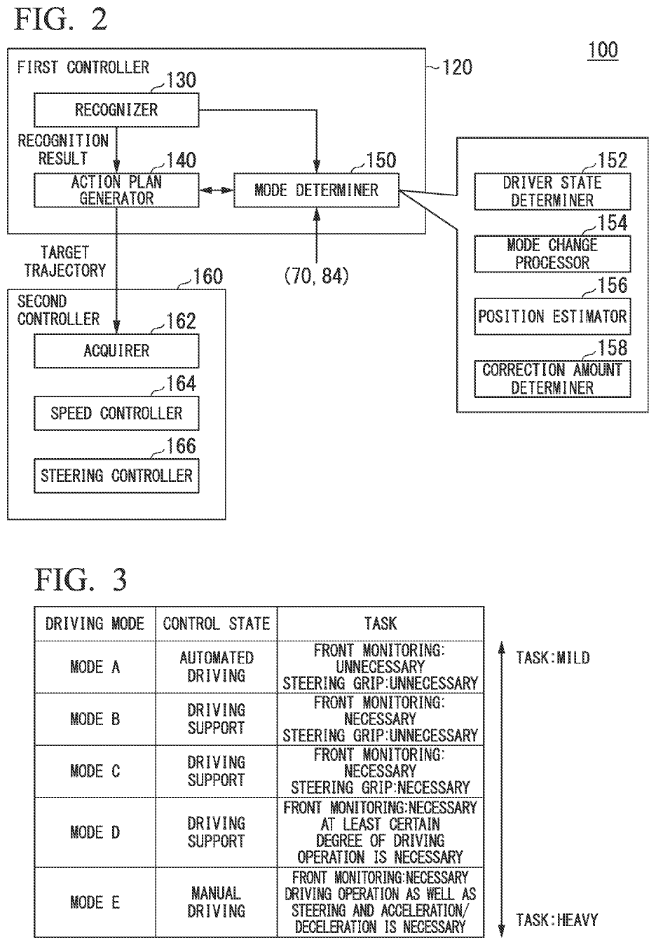

FIG. 2 is a diagram illustrating a functional configuration of the first controller 120 and the second controller 160. The first controller 120 includes, for example, a recognizer 130, an action plan generator 140, and a mode determiner 150. The combination of the action plan generator 140 and the second controller 160, or the combination of the action plan generator 140, the mode determiner 150, and the second controller 160 is an example of the “driving controller”.

For example, the first controller 120 realizes the functions of artificial intelligence (AI) and the functions of a predetermined model in parallel. For example, a function of “recognizing an intersection” may be realized by executing recognition of an intersection by deep learning and the like and recognition based on a predetermined condition (signals, lane marks, and the like which can be subjected to pattern matching) in parallel and scoring both recognition results to make comprehensive evaluation. In this way, the reliability of automated driving is secured.

The recognizer 130 recognizes the situation or environment around the host vehicle M. For example, the recognizer 130 recognizes an object present in the vicinity of the host vehicle M based on the information input from the camera 10, the radar device 12, and the LIDAR 14 via the object recognition device 16. Objects recognized by the recognizer 130 include, for example, bicycles, motorcycles, four-wheeled vehicles, pedestrians, road signs, road markings, lane marks, utility poles, guardrails, falling objects, and the like. Further, the recognizer 130 recognizes the state such as the position of the object, the speed, and the acceleration. The object position is recognized as the position (that is, a relative position with respect to the host vehicle M) on an absolute coordinate system in which a representative point (the center of gravity, the center of a driving shaft, or the like) of the host vehicle M is at the origin, for example, and is used for control. The object position may be represented by a representative point such as the center of gravity or a corner of the object and may be represented by a region. The “state” of an object may include the acceleration or a jerk of an object or an “action state” (for example, whether the object has changed or is trying to change lanes).

For example, the recognizer 130 recognizes a lane (a host lane) in which the host vehicle M is traveling, an adjacent lane adjacent to the host lane, and the like. For example, the recognizer 130 recognizes the space between lane marks as a host lane or an adjacent lane by acquiring the second map information 62 from the MPU 60 and comparing a pattern (for example, an arrangement of solid lines and broken lines) of lane marks included in the acquired second map information 62 and a pattern of lane marks around the host vehicle M recognized from the images captured by the camera 10.

The recognizer 130 may recognize a lane such as a host lane or an adjacent lane by recognizing runway boundaries (road boundaries) including lane marks, road shoulders, roadsides, curbs, a median strip, guard rails, and the like without being limited to the lane marks. In this recognition, the position of the host vehicle M acquired from the navigation device 50 and the processing results of the inertial navigation unit 45 may be also taken into consideration. The recognizer 130 recognizes a temporary stop line, an obstacle, a red sign, a toll booth, and other road events.

When recognizing the host lane, the recognizer 130 recognizes the relative position and direction of the host vehicle M in relation to the host lane. For example, the recognizer 130 may recognize an offset from a lane center of a reference point of the host vehicle M and an angle between the traveling direction of the host vehicle M and an extension line of the coordinate points of the lane center as the relative position and the direction of the host vehicle M in relation to the host lane. Instead of this, the recognizer 130 may recognize the position or the like of the reference point of the host vehicle M in relation to any one of side ends (lane marks or road boundaries) of the host lane as the relative position of the host vehicle M in relation to the host lane.

In principle, the action plan generator 140 generates a target trajectory along which the host vehicle M travels in the future automatically (regardless of an operation of a driver) so that the host vehicle M travels in the recommended lane determined by the recommended lane determiner 61 and it is possible to cope with a surrounding situation of the host vehicle M. The target trajectory includes a speed element, for example. For example, the target trajectory is represented as a sequential arrangement of positions (trajectory points) that the host vehicle M has to reach. The trajectory points are positions that the host vehicle M has to reach every predetermined travel distance (for example, approximately every several [m]) as the distance along a road. In addition to this, a target speed and a target acceleration every predetermined sampling period (for example, approximately every 0.x [sec]) are generated as part of the target trajectory. The trajectory points may be the positions that the host vehicle M has to reach at respective sampling time points of the predetermined sampling periods. In this case, the information of the target speed and the target acceleration is represented by the intervals of the trajectory points.

The action plan generator 140 may set an automated driving event when generating the target trajectory. The automated driving event includes a constant speed travel event, a low-speed pilot travel event, a lane change event, a branching event, a merging event, a takeover event, and the like. The action plan generator 140 generates a target trajectory according to the activated event.

The mode determiner 150 determines any one of a plurality of driving modes in which the driver is assigned with different tasks as the driving mode of the host vehicle M. The mode determiner 150 includes, for example, a driver state determiner 152, a mode change processor 154, a position estimator 156, and a correction amount determiner 158. These individual functions will be described later.

FIG. 3 is a diagram illustrating an example of the correspondence between the driving mode, the control state of the host vehicle M, and the task. The driving mode of the host vehicle M includes, for example, five modes of mode A to mode E. The degree of automation of the control state, that is, the driving control of the host vehicle M, is highest in mode A, decreasing in the order of mode B, mode C, and mode D, and is lowest in mode E. On the contrary, the task assigned to the driver (occupant) is smallest in mode A, increasing in the order of mode B, mode C, and mode D, and is largest in mode E. In modes D and E, the control state is not automated driving. Therefore, the automated driving control device 100 is responsible for operations until ending control related to automated driving and shifting to driving support or manual driving. Hereinafter, the contents of each driving mode will be illustrated.

In mode A, the vehicle is in an automated driving state, and the driver is not assigned with any of the tasks of front monitoring and holding the steering wheel 82 (in the drawing, steering grip). However, even in mode A, the driver is required to be in a posture to quickly shift to manual driving in response to a request from the system centered on the automated driving control device 100. The term “automated driving” as used herein means that both the steering and acceleration are controlled without depending on the driver's operation. The front means the space in the traveling direction of the host vehicle M that is visually recognized through the front windshield. For example, mode A is a driving mode that can be executed when a condition that the host vehicle M is traveling at a predetermined speed (for example, about 50 [km/h]) or less on an automobile-only road such as a highway, and a following target preceding vehicle traveling in the same lane as the host vehicle M or a recommended lane is present is satisfied, and mode A may be called a traffic jam pilot mode (TJP mode). When this condition is not satisfied, the mode determiner 150 changes the driving mode of the host vehicle M to mode B.

In mode B, the vehicle is in a driving support state, and the driver is assigned with a task of monitoring the front of the host vehicle M (hereinafter, front monitoring), but is not assigned with a task of holding the steering wheel 82. In mode C, the vehicle is in a driving support state, and the driver is assigned with a front monitoring task and a task of holding the steering wheel 82. Mode D is a driving mode in which a certain degree of driving operation by the driver is required for at least one of steering and acceleration/deceleration of the host vehicle M. For example, in mode D, driving support such as adaptive cruise control (ACC) and lane keeping assistance system (LKAS) is performed. In mode E, the vehicle is in a manual driving state in which the driving operation by the driver is required for steering and acceleration/deceleration. In both mode D and mode E, the driver is naturally assigned with a task of monitoring the front of the host vehicle M.

The automated driving control device 100 (and a driving support device (not illustrated)) executes an automated lane change according to a driving mode. The automated lane change includes an automated lane change (1) according to a system request and an automated lane change (2) according to a driver request. The automated lane change (1) includes an automated lane change for passing, performed when the speed of a preceding vehicle is smaller than the speed of the host vehicle by a reference or more and an automated lane change for traveling toward a destination (an automated lane change due to change in the recommended lane). The automated lane change (2) changes the lane of the host vehicle M toward the direction operated by the driver operating a direction indicator when the conditions related to the speed and the positional relationship with the surrounding vehicles are satisfied.

In mode A, the automated driving control device 100 does not execute either the automated lane change (1) or (2). In modes B and C, the automated driving control device 100 executes both the automated lane changes (1) and (2). In mode D, the driving support device (not illustrated) does not execute the automated lane change (1) but executes the automated lane change (2). In mode E, neither the automated lane change (1) nor (2) is executed.

The mode determiner 150 changes the driving mode of the host vehicle M to a driving mode in which the task is heavier when the task related to the determined driving mode is not executed by the driver.

For example, in mode A, when the driver is in a posture where he/she cannot shift to manual driving in response to a request from the system (for example, when he/she continues to look outside the permissible area, or when a sign that driving becomes difficult is detected), the mode determiner 150 uses the HMI 30 to urge the driver to shift to manual driving, and performs control such that if the driver does not respond, the host vehicle M is moved to the road shoulder and gradually stopped, and automated driving is stopped. After the automated driving is stopped, the host vehicle M is in mode D or E, and the host vehicle M can be started by the manual operation of the driver. Hereinafter, the same applies to “stopping of automated driving”. In mode B, when the driver is not monitoring the front, the mode determiner 150 uses the HMI 30 to urge the driver to monitor the front, and performs control such that if the driver does not respond, the host vehicle M is moved to the shoulder of the road and gradually stopped, and automated driving is stopped. In mode C, if the driver is not monitoring the front, or is not holding the steering wheel 82, the mode determiner 150 uses the HMI 30 to urge the driver to monitor the front and/or hold the steering wheel 82, and performs control such that if the driver does not respond, the host vehicle M is moved to the shoulder of the road and gradually stopped, and automated driving is stopped.

The driver state determiner 152 monitors the driver's state for changing the mode, and determines whether the driver's state is in a state corresponding to the task. For example, the driver state determiner 152 analyzes the image captured by the driver monitor camera 70 to perform posture estimation processing, and determines whether the driver is in a posture where he/she cannot shift to manual driving in response to a request from the system. The driver state determiner 152 analyzes the image captured by the driver monitor camera 70 to perform line-of-sight estimation processing and determines whether the driver is monitoring the front.

The mode change processor 154 performs various processes for changing the mode. For example, the mode change processor 154 instructs the action plan generator 140 to generate a target trajectory for stopping at a road shoulder, gives an operation instruction to a driving support device (not illustrated), or controls the HMI 30 to urge the driver to perform an action.

The position estimator 156 estimates the position of the host vehicle M based on the pulse signal output by the wheel speed sensor 42. For example, the position estimator 156 counts the pulse signals output from the wheel speed sensor 42 and converts the number of counted pulse signals (that is, the rotation speed (rotational speed) of the wheels) to the travel distance that the host vehicle M may have traveled. Then, the position estimator 156 estimates the position traveled by the travel distance from the position where the counting of the pulse signals is started as the current position of the host vehicle M. The combination of the wheel speed sensor 42 and the position estimator 156 is another example of the “second measurer”.

The correction amount determiner 158 determines a correction amount of the position (hereinafter referred to as “satellite observation position P2”) of the host vehicle M estimated by the position estimator 156 on the basis of the position (hereinafter referred to as “satellite observation position P1”) of the host vehicle M measured by the GNSS receiver 51 and the vehicle speed observation position P2. The satellite observation position P1 is an example of the “first position”, and the vehicle speed observation position P2 is an example of the “second position”.

The correction amount is some value that is added, subtracted, multiplied, or divided with respect to the vehicle speed observation position P2 in order to bring the vehicle speed observation position P2, which is an observed value, closer to the satellite observation position P1 which is also an observed value. For example, the correction amount may be a weighting coefficient α that is multiplied with respect to an explanatory variable when the vehicle speed observation position P2 is used as the explanatory variable. The weighting coefficient α is also a ratio (that is, a gain) between the satellite observation position P1 and the vehicle speed observation position P2. In addition to the weighting coefficient α, the correction amount may further include a bias component β to be added to the explanatory variables. Further, the correction amount may include an exponent of an exponential function or a base of a logarithmic function, or may include various parameters of machine learning (for example, a weighting coefficient or a bias component of a neural network).

For example, the correction amount determiner 158 calculates the difference Δ between the satellite observation position P1 and the vehicle speed observation position P2 in order to bring the vehicle speed observation position P2 closer to the satellite observation position P1, and determines the correction amount of the vehicle speed observation position P2 so that the difference Δ decreases.

The vehicle speed observation position P2 is not limited to the position of the host vehicle M estimated by the position estimator 156, and may be the position of the host vehicle M measured or calculated by the inertial navigation unit 45, or may be the average of these two positions.

The second controller 160 controls the travel drive force output device 200, the brake device 210, and the steering device 220 so that the host vehicle M passes the target trajectory generated by the action plan generator 140 at the scheduled time.

Returning to FIG. 2, the second controller 160 includes, for example, an acquirer 162, a speed controller 164, and a steering controller 166. The acquirer 162 acquires information on the target trajectory (trajectory points) generated by the action plan generator 140 and stores the information in a memory (not illustrated). The speed controller 164 controls the travel drive force output device 200 or the brake device 210 on the basis of a speed element included in the target trajectory stored in the memory. The steering controller 166 controls the steering device 220 according to the degree of curving of the target trajectory stored in the memory. The processes of the speed controller 164 and the steering controller 166 are realized by a combination of feedforward control and feedback control, for example. As an example, the steering controller 166 executes feedforward control according to the curvature of a road in front of the host vehicle M and feedback control based on an offset from a target trajectory in combination.

The travel drive force output device 200 outputs a travel drive force (torque) for a vehicle to travel to driving wheels. The travel drive force output device 200 includes, for example, a combination of an internal combustion engine, an electric motor, and a transmission and an electronic controller (ECU) that controls these components. The ECU controls the above-mentioned components according to the information input from the second controller 160 or the information input from the driving operator 80.

The brake device 210 includes, for example, a brake caliper, a cylinder that delivers hydraulic pressure to the brake caliper, an electric motor that generates hydraulic pressure in the cylinder, and a brake ECU. The brake ECU controls the electric motor according to the information input from the second controller 160 or the information input from the driving operator 80 so that brake torque corresponding to a braking operation is output to each wheel. The brake device 210 may include a backup mechanism that delivers hydraulic pressure generated by an operation of a brake pedal included in the driving operator 80 to a cylinder via a master cylinder. The brake device 210 is not limited to the above-described configuration and may be an electrically-controlled hydraulic-pressure brake device that controls an actuator according to information input from the second controller 160 and delivers hydraulic pressure of the master cylinder to a cylinder.

The steering device 220 includes, for example, a steering ECU and an electric motor. The electric motor, for example, applies a force to a rack-and-pinion mechanism to change the direction of a steering wheel. The steering ECU drives an electric motor according to the information input from the second controller 160 or the information input from the driving operator 80 to change the direction of the steering wheel.

### Training Process

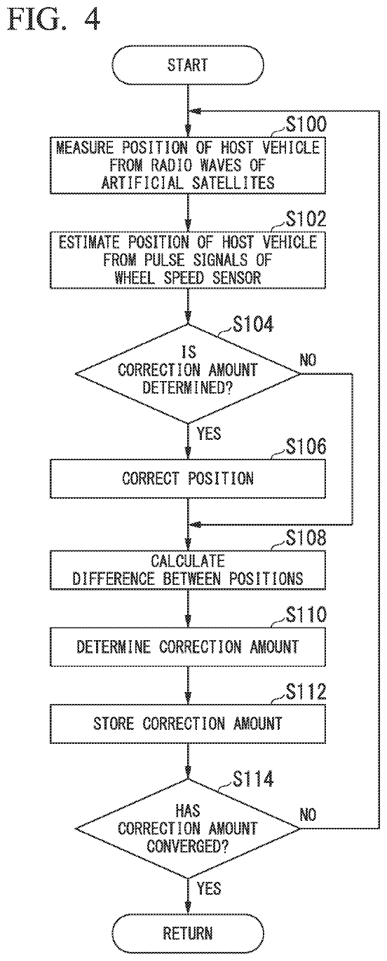

Hereinafter, the training process of the vehicle system 1 will be described with reference to the flowchart. The training process is for learning the correction amount in advance, and more specifically, to repeatedly determine the correction amount and uniquely identify a value therefor. FIG. 4 is a flowchart illustrating an example of the training process of the vehicle system 1. The process of this flowchart may be repeatedly executed at predetermined time intervals during the period in which the GNSS receiver 51 is receiving radio waves from GNSS satellites.

First, the GNSS receiver 51 receives radio waves from GNSS satellites and measures the position of the host vehicle M based on the signals of the received radio waves (step S100).

Next, the position estimator 156 estimates the position of the host vehicle M based on the pulse signal output by the wheel speed sensor 42 (step S102).

Next, the correction amount determiner 158 determines whether the correction amount of the vehicle speed observation position P2, which is the position of the host vehicle M estimated by the position estimator 156, has already been determined (step S104). For example, the correction amount determiner 158 refers to a storage device (HDD, flash memory, and the like) of the automated driving control device 100, and determines that the correction amount of the vehicle speed observation position P2 has already been determined when a correction amount is stored therein.

When the correction amount of the vehicle speed observation position P2 has already been determined, the correction amount determiner 158 corrects the current vehicle speed observation position P2 estimated by the process of S102 based on the most recent correction amount among the correction amounts stored in the storage device of the automated driving control device 100 (step S106).

For example, when the correction amount includes the weighting coefficient a and the bias component β, the correction amount determiner 158 corrects the current vehicle speed observation position P2 by multiplying the vehicle speed observation position P2 by the weighting coefficient α and further adding the bias component β thereto.

When the correction amount of the vehicle speed observation position P2 has not yet been determined, the correction amount determiner 158 proceeds to the next process of S108 without correcting the current vehicle speed observation position P2 (that is, the process of S106 is omitted).

Next, the correction amount determiner 158 calculates the difference Δ between the satellite observation position P1 which is the position of the host vehicle M measured by the GNSS receiver 51 and the corrected/non-corrected vehicle speed observation position P2 (step S108).

For example, if the process of S106 is omitted, the correction amount determiner 158 calculates the difference Δ between the satellite observation position P1 and the non-corrected vehicle speed observation position P2. If the process of S106 is executed, the correction amount determiner 158 calculates the difference Δ between the satellite observation position P1 and the corrected vehicle speed observation position P2.

Next, the correction amount determiner 158 determines the correction amount of the vehicle speed observation position P2 so that the calculated difference Δ decreases (step S110).

Next, the correction amount determiner 158 stores the determined correction amount of the vehicle speed observation position P2 in the storage device of the automated driving control device 100 (step S112).

Next, the correction amount determiner 158 determines whether the determined correction amount of the vehicle speed observation position P2 has converged (step S114).

For example, the correction amount determiner 158 compares the correction amount determined up to the previous time and stored in the storage device with the correction amount determined in this processing, and determines that the correction amount has converged if the error of the correction amount is within an allowable range. The allowable range is a numerical range that allows an error to the extent that the two correction amounts to be compared are considered to be the same.

On the other hand, if the error of the correction amount is outside of the allowable range, the correction amount determiner 158 determines that the correction amount has not converged.

When the correction amount determiner 158 determines that the correction amount has converged, the process of this flowchart ends.

On the other hand, when the correction amount determiner 158 determines that the correction amount has not converged, the process returns to S100. As a result, by repeatedly determining the correction amount, the satellite observation position P1 and the vehicle speed observation position P2 are repeatedly obtained until the correction amount of the vehicle speed observation position P2 converges to a constant value.

For example, it may be assumed that the current processing is n (n is an arbitrary natural number) and the previous processing is n-1. In this case, the correction amount determiner 158 corrects the n-th vehicle speed observation position P2 based on the correction amount determined at the (n-1)th time. The correction amount determiner 158 calculates the difference Δ between the corrected n-th vehicle speed observation position P2 and the n-th satellite observation position P1 and determines the correction amount of the n-th vehicle speed observation position P2 so that the difference Δ decreases, that is, the corrected n-th vehicle speed observation position P2 approaches the n-th satellite observation position P1. In this way, the correction amount determiner 158 repeatedly determines the current correction amount while reflecting the previous correction amount.

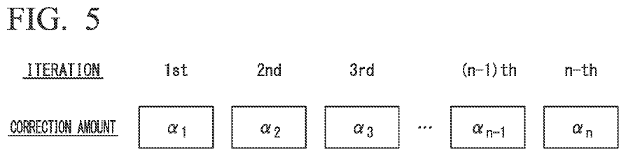

FIG. 5 is a diagram showing the convergence determination of the correction amount. Here, the correction amount is only the weighting coefficient α. For example, it is assumed that the number of iterations (number of repetitions) for determining the correction amount has increased to 1, 2, 3, . . . , n-1, and n. When the number of iterations is n, the correction amount determiner 158 may determine whether an error between the weighting coefficient αₙ determined as the n-th correction amount and the weighting coefficient αₙ₋₁ determined as the (n-1)th correction amount is within the allowable range and may determine whether the correction amount has converged according to the determination result.

Further, the correction amount determiner 158 may determine that the correction amount has converged when there is no change in the moving average obtained by taking not only the correction amount determined most recently but also a predetermined number of past correction amounts into consideration. For example, when the past three correction amounts are taken into consideration, the correction amount determiner 158 may determine whether the correction amount has converged based on the moving averages of the weighting coefficients αₙ₋₃, αₙ₋₂, αₙ₋₁, and αₙ.

### Run-Time Processing in Time of Abnormality

Hereinafter, the runtime processing at the time of abnormality by the vehicle system 1 will be described with reference to the flowchart. The runtime processing at the time of abnormality is to automatically drive the host vehicle M using the correction amount determined in advance in the training process when a specific abnormality occurs (including the case where the probability is high). The specific abnormality means that, for example, the GNSS receiver 51 cannot measure the position of the host vehicle M.

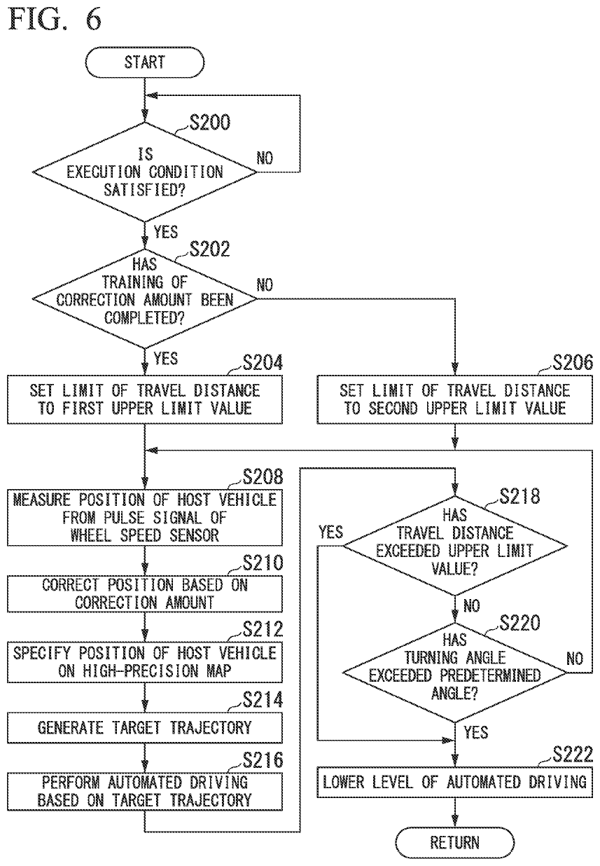

FIG. 6 is a flowchart illustrating an example of runtime processing at the time of abnormality by the vehicle system 1.

First, the action plan generator 140 waits until an execution condition is satisfied (step S200). The execution condition is a condition for executing the runtime process of this flowchart, and includes some of the following conditions.

Condition (i): A specific abnormality has occurred (the GNSS receiver 51 could not measure the position of the host vehicle M).

Condition (ii): The automated driving control device 100 could acquire the second map information 62 from the MPU 60.

Condition (iii): The host vehicle M is not traveling in the prohibited section of mode A or mode B.

Condition (iv): No abnormality has occurred in the second map information 62.

For example, the action plan generator 140 determines that the condition (i) is satisfied if the flag signal output from the GNSS receiver 51 does not return to a positioning flag signal within a predetermined time (for example, between 10 and 20 seconds) after the flag signal changes from the positioning flag signal to a non-positioning flag signal.

Instead of or in addition to this, the action plan generator 140 may determine that the condition (i) is satisfied when the flag signal output from the GNSS receiver 51 does not return to the positioning flag signal within a period in which the host vehicle M travels a predetermined distance (for example, hundreds of meters) after the flag signal changes from the positioning flag signal to the non-positioning flag signal.

As described above, the action plan generator 140 determines that the condition (i) is satisfied when the period in which the GNSS receiver 51 could not receive the radio waves from the GNSS satellites (or the period in which the signal strength of the radio waves is less than the threshold value) continues over a predetermined time (or a predetermined distance). That is, the action plan generator 140 determines that a specific abnormality has occurred (the GNSS receiver 51 cannot measure the position of the host vehicle M).

For example, a specific abnormality is likely to occur when the host vehicle M is traveling in a place where the radio waves of the GNSS satellites are easily blocked or reflected, such as in tunnels, or under elevated buildings, or high-rise buildings. Further, a specific abnormality can occur when the GNSS receiver 51 has a hardware or software failure, or when the host vehicle M travels in a place where other radio waves having the same frequency band as the radio waves of the GNSS satellites are transmitted, or when a failure occurs in a GNSS satellite (for example, a quasi-zenith satellite).

Therefore, the action plan generator 140 can easily determine that the condition (i) is satisfied, that is, a specific abnormality has occurred in the above-mentioned various cases (situations).

The action plan generator 140 determines whether the training of the correction amount of the vehicle speed observation position P2 has been completed when at least (i) of the execution conditions (i) to (iv) is satisfied (preferably when all of (i) to (iv) are satisfied) (step S202).

For example, the action plan generator 140 determines that the training of the correction amount has been completed when the correction amount of the vehicle speed observation position P2 has converged at the time of the training process and determines that the training of the correction amount has not been completed when the correction amount of the vehicle speed observation position P2 has not converged at the time of the training process. The action plan generator 140 may determine that the training of the correction amount has not been completed even when the training process has never been started and no correction amount is stored in the storage device of the automated driving control device 100.

When it is determined that the training of the correction amount is completed, the action plan generator 140 sets the limit of the distance that can be continuously traveled by the automated driving to a first upper limit value (step S204).

On the other hand, when it is determined that that the training of the correction amount is not completed, the action plan generator 140 sets the limit of the distance that can be continuously traveled by the automated driving to a second upper limit value smaller than the first upper limit value (step S206).

The first upper limit value is set to, for example, about between 10 to 20 [km], and the second upper limit value is set to, for example, about between 1 to 10 [km].

In addition, the action plan generator 140 may set the limit of the “time” that the vehicle can continue to travel by automated driving depending on whether the training of the correction amount is completed, instead of or in addition to setting the limit of “distance” that can be continuously traveled by automated driving.

For example, the action plan generator 140 may set the limit of the time that the vehicle can continue to travel by automated driving to a third upper limit value when it is determined that the training of the correction amount is completed and may set the limit of the time that the vehicle can continue to travel by automated driving to a fourth upper limit value smaller than the third upper limit value when it is determined that the training of the correction amount has not been completed.

Next, the position estimator 156 estimates the vehicle speed observation position P2 based on the pulse signal output by the wheel speed sensor 42 (step S208).

For example, the position estimator 156 counts the pulse signals output from the wheel speed sensor 42 from the last satellite observation position P1 measured by the GNSS receiver 51 (or the point where the satellite observation position P1 is no longer measured by the GNSS receiver 51) and converts the number of counted pulse signals (that is, the rotation speed (rotational speed) of wheels) to the travel distance that the host vehicle M may have traveled. Then, the position estimator 156 estimates the position traveled by the travel distance from the point where the pulse signal counting is started as the vehicle speed observation position P2.

Next, the correction amount determiner 158 corrects the current vehicle speed observation position P2 estimated in the process of S208 based on the correction amount (step S210).

In the training process, the correction amounts determined repeatedly are stored in the storage device at any time until the training of the correction amount is completed (until the correction amount converges). That is, a plurality of correction amount candidates to be used in the process of S210 is stored in the storage device. Therefore, the correction amount determiner 158 reads one of the plurality of correction amounts stored in the storage device during the period until the training of the correction amount is completed from the storage device, and corrects the current vehicle speed observation position P2 estimated by the process of S208 using the read correction amount.

For example, the correction amount determiner 158 may select the last correction amount determined in the training process from the plurality of correction amounts, and correct the vehicle speed observation position P2 using the selected correction amount. Further, the correction amount determiner 158 may select the correction amount having the smallest difference Δ from the satellite observation position P1 in the training process from the plurality of correction amounts, and correct the vehicle speed observation position P2 using the selected correction amount.

If the training process has never been started and no correction amount is stored in the storage device of the automated driving control device 100, the process of S210 may be omitted.

Next, the MPU 60 specifies the position where the host vehicle M is present on the second map information 62 (high-precision map) using the vehicle speed observation position P2 corrected by the correction amount determiner 158 instead of using the satellite observation position P1 measured by the GNSS receiver 51 (step S212).

Specifically, the MPU 60 sets the vehicle speed observation position P2 corrected by the correction amount determiner 158 as the position of the host vehicle M on the second map information 62. At this time, the MPU 60 may determine the recommended lane again.

Next, the action plan generator 140 generates a target trajectory based on the position of the host vehicle M specified on the second map information 62 by the MPU 60, that is, the corrected vehicle speed observation position P2 (step S214).

For example, the action plan generator 140 determines the future position that the host vehicle M should reach from the corrected vehicle speed observation position P2 as the starting point as a trajectory point, and further determines the target speed and the target acceleration from the starting point. Then, the action plan generator 140 generates a trajectory in which a plurality of trajectory points that the host vehicle M should reach in the future are arranged in time series and are associated with a target speed and a target acceleration as the target trajectory of the host vehicle M.

Next, the second controller 160 performs automated driving by controlling the travel drive force output device 200, the brake device 210, and the steering device 220 based on the target trajectory (the target trajectory using the vehicle speed observation position P2) generated by the action plan generator 140 (step S216).

Next, the mode change processor 154 determines whether the distance traveled by the host vehicle M during automated driving exceeds the upper limit value (first upper limit value or second upper limit value) of the distance set in the process of S204 or S206 (step S218).

When the upper limit value of time is set in the process of S204 or S206, the mode change processor 154 may determine that the time that the host vehicle M has traveled during automated driving exceeds the upper limit value (third upper limit value or fourth upper limit value) of the time set in the process of S204 or S206.

When the distance (or time) traveled by the host vehicle M during automated driving is equal to or less than the upper limit value set in the process of S204 or S206, the mode change processor 154 further determines whether the angle (hereinafter, turning angle) θ of the wheel or the vehicle body when the host vehicle M turns in the same direction exceeds a predetermined angle (step S220).

The predetermined angle can be regarded as an angle over which the host vehicle M can make one turn, and is, for example, an angle within a range of about 270 degrees to 360 degrees.

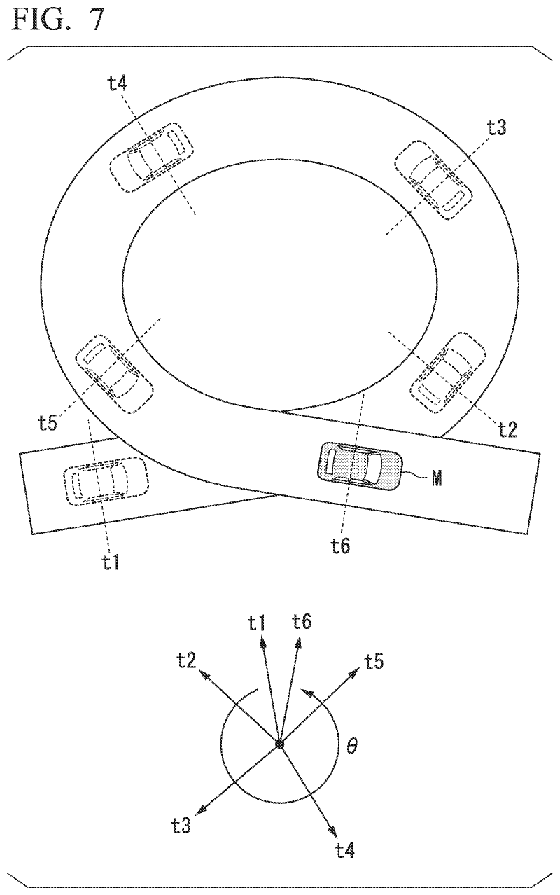

FIG. 7 is a diagram illustrating an example of a situation in which the turning angle θ of the host vehicle M exceeds a predetermined angle. As illustrated in the drawing, a rampway of a highway, a roundabout intersection, and the like have a circular or arcuate road shape when viewed from above. When the host vehicle M travels on such a road, the turning angle θ of the host vehicle M increases as the time t1, t2, t3, t6 progresses, and reaches an angle close to 360 degrees. Therefore, the mode change processor 154 determines that the turning angle θ of the host vehicle M exceeds a predetermined angle when the host vehicle M travels on a circular or arcuate road.

Returning to the description of the flowchart of FIG. 6, when the distance (or time) traveled by the host vehicle M during automated driving is not more than the upper limit value and the turning angle θ of the host vehicle M is not more than a predetermined angle, the mode change processor 154 returns the processing to S208. That is, the automated driving based on the vehicle speed observation position P2 is continued.

On the other hand, when the distance (or time) traveled by the host vehicle M during automated driving exceeds the upper limit value or the turning angle θ of the host vehicle M exceeds a predetermined angle, the mode change processor 154 changes the driving mode to an automatic driving mode with a lower control level (step S222). That is, the mode change processor 154 lowers the control level of the automated driving. In this way, the processing of this flowchart ends.

For example, when the driving mode of the host vehicle M is mode A or mode B, the mode change processor 154 changes the mode to mode C or mode D with a lower control level than mode B. In other words, when the driving mode of the host vehicle M is mode A or mode B, the mode change processor 154 changes the mode to mode C or mode D in which heavier duties (more tasks) are assigned to the occupant than mode B.

As described above, mode A and mode B are modes in which holding of the steering wheel 82 is not assigned to the occupant as a duty. In contrast, mode C or mode D is a mode in which holding of the steering wheel 82 is assigned to the occupant as a duty. Therefore, when the distance (or time) traveled by the host vehicle M during automated driving exceeds the upper limit value, or the turning angle θ of the host vehicle M exceeds a predetermined angle, the mode change processor 154 changes the driving mode of the host vehicle M to a mode in which holding of the steering wheel 82 is assigned to the occupant as a duty.

Further, in mode E, which is a manual driving mode, holding of the steering wheel 82 is assigned to the occupant as a duty. Therefore, when the distance (or time) traveled by the host vehicle M during automated driving exceeds the upper limit value, or when the turning angle θ of the host vehicle M exceeds a predetermined angle, the mode change processor 154 may change any of the automatic driving modes to mode E.

According to the embodiment described above, when the correction amount is not sufficiently learned by the correction amount determiner 158 in the training process under the condition that the GNSS receiver 51 could not measure the position of the host vehicle M, the mode change processor 154 lowers the control level of the automated driving in a shorter travel distance or travel time as compared with the case where the correction amount is sufficiently learned by the correction amount determiner 158 in the training process. In other words, if the training process has never been executed or the number of executions is not sufficient and the correction amount has not converged, the mode change processor 154 lowers the control level of the automated driving in a shorter travel distance or travel time under the condition that the GNSS receiver 51 could not measure the position of the host vehicle M as compared with the case where the training process has been executed several times and the correction amount has converged. In this way, the control level of automated driving can be changed under appropriate conditions according to the execution status of the training of the correction amount.

### OTHER EMBODIMENTS (MODIFICATIONS)

Hereinafter, other embodiments (modifications) will be described. In the above-described embodiment, the limit of the distance or time that can be continuously traveled by the automated driving is set according to the two determination results of whether the training of the correction amount is completed, but there is no limitation thereto.

For example, the action plan generator 140 may increase the limit of distance or time as the number of trainings of the correction amount (the number of repetitions of determination of the correction amount) increases. In other words, the action plan generator 140 may increase the travel distance (first upper limit value or second upper limit value) until the control level of automated driving is lowered and may increase the travel time (third upper limit value or fourth upper limit value) until the control level of automated driving is lowered as the number of trainings of the correction amount (number of repetitions of determination of the correction amount) increases.

### SUPPLEMENTARY NOTES

The above-described embodiments may be expressed as follows.

### Expression Example 1

A vehicle control device including: a memory that stores a program; and a hardware processor, wherein the hardware processor executes the program to execute: measuring a position of a vehicle based on radio waves coming from artificial satellites; measuring the position of the vehicle based on an index that represents a behavior of the vehicle; calculating a difference between a first position, which is the position of the vehicle measured based on the radio waves, and a second position, which is the position of the vehicle measured based on the index, and determining a correction amount of the second position based on the calculated difference; and performing automated driving of the vehicle based on the first position measured or the second position corrected based on the correction amount; when the correction amount is not determined, lowering a control level of the automated driving in a shorter travel distance or travel time under a condition that the first position is not measured as compared with a case where the correction amount is determined.

### Expression Example 2

A vehicle control device including: a memory that stores a program; and a hardware processor, wherein the hardware processor executes the program to execute: measuring a position of a vehicle based on radio waves coming from artificial satellites; measuring the position of the vehicle based on an index that represents a behavior of the vehicle; calculating a difference between a first position, which is the position of the vehicle measured based on the radio waves, and a second position, which is the position of the vehicle measured based on the index, and determining a correction amount of the second position based on the calculated difference; determining any one of a plurality of driving modes including a first driving mode (for example, mode C, mode D, or mode E) and a second driving mode (for example, mode A or mode B) in which a driver is assigned a milder task than in the first driving mode as a driving mode of the vehicle based on the first position measured or the second position corrected based on the correction amount; controlling at least one of steering and acceleration/deceleration of the vehicle according to the determined driving mode; changing the driving mode of the vehicle to a driving mode in which the driver is assigned a heavier task when the task in the determined driving mode is not executed by the driver; and when the correction amount is not determined, changing the driving mode of the vehicle to a driving mode in which the driver is assigned a heavier task in a shorter travel distance or travel time under a condition that the first position is not measured as compared with the correction amount is not determined.

While aspects for carrying out the present invention have been described using embodiments, the present invention is not limited to these embodiments, and various changes and substitutions can be made without departing from the spirit of the present invention.

What is claimed is:

1. A vehicle control device comprising:
a first measurer that measures a position of a vehicle based on radio waves coming from artificial satellites;
a second measurer that measures the position of the vehicle based on an index that represents a behavior of the vehicle;
a determiner that calculates a difference between a first position, which is the position of the vehicle measured by the first measurer, and a second position, which is the position of the vehicle measured by the second measurer, and determines a correction amount of the second position based on the calculated difference; and
a driving controller that performs automated driving of the vehicle based on the first position measured by the first measurer or the second position corrected based on the correction amount determined by the determiner, wherein
when the correction amount is not determined by the determiner, the driving controller lowers a control level of the automated driving in a shorter travel distance or travel time under a condition that the first position is not measured by the first measurer as compared with a case where the correction amount is determined by the determiner.

2. The vehicle control device according to claim 1, wherein
the first measurer repeatedly measures the first position,
the second measurer repeatedly measures the second position,
the determiner repeats calculating the difference between the first position and the second position corrected based on the correction amount and determining the correction amount based on the calculated difference each time the first position and the second position are repeatedly measured, and
when the first position is not measured by the first measurer, the driving controller performs the automated driving based on the second position corrected based on the correction amount determined latest or the correction amount having the smallest difference among a plurality of correction amounts determined repeatedly by the determiner.

3. The vehicle control device according to claim 2, wherein
the driving controller increases the travel distance or the travel time until the control level of the automated driving is lowered as the number of repetitions of the determination of the correction amount increases.

4. The vehicle control device according to claim 1, wherein
the driving controller further lowers the control level of the automated driving when an turning angle when the vehicle turns in the same direction exceeds a predetermined angle.

5. A vehicle control method for causing a computer mounted on a vehicle to execute:
measuring a position of a vehicle based on radio waves coming from artificial satellites;
measuring the position of the vehicle based on an index that represents a behavior of the vehicle;
calculating a difference between a first position, which is the position of the vehicle measured based on the radio waves, and a second position, which is the position of the vehicle measured based on the index, and determining a correction amount of the second position based on the calculated difference; and
performing automated driving of the vehicle based on the first position measured by the first measurer or the second position corrected based on the correction amount;
when the correction amount is not determined, lowering a control level of the automated driving in a shorter travel distance or travel time under a condition that the first position is not measured as compared with a case where the correction amount is determined.

6. A computer-readable non-transitory storage medium storing a program for causing a computer mounted on a vehicle to execute:
measuring a position of a vehicle based on radio waves coming from artificial satellites;
measuring the position of the vehicle based on an index that represents a behavior of the vehicle;
calculating a difference between a first position, which is the position of the vehicle measured based on the radio waves, and a second position, which is the position of the vehicle measured based on the index, and determining a correction amount of the second position based on the calculated difference; and
performing automated driving of the vehicle based on the first position measured by the first measurer or the second position corrected based on the correction amount;
when the correction amount is not determined, lowering a control level of the automated driving in a shorter travel distance or travel time under a condition that the first position is not measured as compared with a case where the correction amount is determined.
